(19) United States
(12) Patent Application Publication
(10) Pub. No.: US 2026/0141761 A1
(43) Pub. Date: May 21, 2026

(54) INTELLIGENT CONTROL OF PHYSICAL ACCESS TO RESTRCTED AREAS

(71) Applicant: MOTOROLA SOLUTIONS, INC., Chicago, IL (US)

(72) Inventors: Behnam Shahbazi, Santa Clara, CA (US); Amir Khakpour, Los Angeles, CA (US); Robert Peters, Culver City, CA (US)

(21) Appl. No.: 18/949,441

(22) Filed: Nov. 15, 2024

(51) Int. Cl. G07C 9/00; G06F 8/30; G06F 40/20

(52) U.S. Cl. CPC G07C 9/00309; G06F 8/30; G06F 40/20

(57) ABSTRACT

Examples provide a system for controlling physical access to a restricted area. The system includes an electronic processor configured to receive, from a system user, a natural language input relating to an expected event at a physical access device, and generate, using an artificial intelligence (AI) model, a configuration file for the physical access device based on the natural language input. The configuration file defines a set of actions and a set of conditions for performing the set of actions. The electronic processor activates the configuration file in response to determining that the system user has sufficient user permissions. The electronic processor detects, via an input device, activity in proximity to the restricted area, and, in response to determining that the activity satisfies at least one condition defined by the configuration file, executes the set of actions. At least one action controls the physical access device.

### BACKGROUND

Examples described herein relate to controlling access to restricted areas, such as office buildings, manufacturing facilities, government buildings, schools, or the like.

### BRIEF DESCRIPTION OF THE DRAWINGS

FIG. 1 illustrates a physical access control system, according to some examples.

FIG. 2 schematically illustrates a physical access control server, according to some examples.

FIG. 3 is a flowchart of a method for performing physical access control of a restricted area, according to some examples.

FIG. 4 illustrates an example image from which a natural language input may be derived, according to some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing only those specific details that are pertinent to understanding the examples of the present disclosure so as not to obscure the disclosure with details that will be readily apparent to those of ordinary skill in the art having the benefit of the description herein.

### DETAILED DESCRIPTION

Access to offices, manufacturing facilities, government buildings, schools, or other areas may be restricted to personnel associated with those areas. In some instances, restricted areas have reception areas (e.g., lobbies) staffed by on-site receptionists or security guards to grant limited access to visitors, such as delivery persons, technicians, or the like. These reception areas are typically only unlocked and/or staffed during certain days and/or hours (e.g., daytime business hours). As a result, some visitors may be unable to access the restricted area, and authorized individuals associated with restricted areas must leave, for example, their workstations to greet visitors.

For example, an employee working in a restricted office building may be working late when the building is locked for the night, and the employee may wish to order food delivery to the office building. Because the office building is locked, the food delivery person may be unable to access a delivery drop-off area, a reception area, or any other part of the restricted area to complete the delivery. As a result, the delivery risks being compromised (e.g., incomplete, stolen, left in an incorrect place, etc.). Alternatively, the employee may subsequently have to leave the restricted office building to collect the delivery, and risk becoming locked out.

As another example, a restricted area may include a restricted roadway, for example, a road or passage having a locked gate. An expected visitor (e.g., delivery person, technician, or the like) driving to the restricted area may be unable to gain access to the restricted roadway if the gate is not staffed (e.g., after hours or the like). As a result, an employee or other authorized person associated with the restricted area and expecting the visitor may be required to leave the building and travel to the gate to greet the visitor.

Because places of business often have many employees, many points of access, and tighter security protocols, conventional home security and home access systems are too simple to be implemented in these places of business. For example, personnel in business places may have different levels of authorization to receive visitors, access certain doors, or the like. Additionally, even if a business implements a configurable technology to handle visitors (e.g., video cameras, keypads, card readers, etc.), if the system is not easy to configure, then the system may be bypassed by employees, thus undermining the established security protocols. In other words, a technology that must be nuanced for professional settings can ultimately create usage hurdles for the employees expected to interact with it. Thus, examples described herein address such technological issues. One example provides a system for controlling physical access to a restricted area. The system includes: a physical access device configured to selectively enable access to the restricted area; and an electronic processor communicatively connected to the physical access device, the electronic processor configured to receive, from a user device associated with a system user, a natural language input relating to an expected event at the physical access device, wherein the system user is associated with a set of user permissions for configuring the physical access device, generate, using an artificial intelligence (AI) model, a configuration file for the physical access device based on the natural language input, the configuration file defining a set of actions and a set of conditions for performing the set of actions, determine whether the system user has sufficient user permissions to activate the configuration file, in response to determining that the system user has sufficient user permissions to activate the configuration file, activate the configuration file, detect, via an input device, activity in proximity to the restricted area, determine whether the activity satisfies at least one condition of the set of conditions defined by the configuration file, and, in response to determining that the activity satisfies at least one condition of the set of conditions defined by the configuration file, execute the set of actions, wherein at least one action of the set of actions controls the physical access device.

In some aspects, the set of actions include at least one selected from a group consisting of: temporarily unlocking the physical access device to the restricted area, generating and transmitting, to the system user, a notification that the event has been detected, generating and transmitting, to user different from the system user, a notification that the event has been detected, generating and outputting, using a speaker device positioned in proximity to the restricted area, an audible instruction, and recording, using at least one camera, image data of a scene in proximity to the restricted area.

In some aspects, the expected event includes at least one selected from a group consisting of an expected visitor to the restricted area and an expected vehicle arrival to the restricted area.

In some aspects, the set of conditions include at least one selected from a group consisting of: a date range, a time of day range, a company associated with the expected event, an identifier of an expected visitor or an expected vehicle, and a confirmation code associated with the expected event.

In some aspects, determining whether the activity satisfies at least one condition of the set of conditions defined by the configuration file includes detecting at least one selected from the group consisting of a company logo worn by a visitor detected at a scene in proximity to the restricted area, a face of the visitor detected at the scene, a confirmation code presented by the visitor at the scene, an object held by the visitor at the scene, and a verbal statement made by the visitor at the scene.

In some aspects, the electronic processor is further configured to determine whether each required field of the configuration file is complete, and in response to determining at least one required field of the configuration file is not complete, prompt the system user, via the user device, to provide additional information relating to the expected event.

In some aspects, determining whether the activity satisfies at least one condition of the set of conditions defined by the configuration file includes generating and outputting, using a speaker device positioned in proximity to the restricted area, a verbal prompt based on the set of conditions.

In some aspects, the verbal prompt includes a request for at least one selected from a group consisting of: a name of a visitor, an intended purpose of the visitor, an intended visitee of the visitor, a company name associated with the visitor, a confirmation code associated with the event.

In some aspects, the electronic processor is further configured to, in response to determining that the system user does not have sufficient user permissions to set the configuration file, prompt, via the user device, the system user to contact a system administrator to request permission to set the configuration file.

In some aspects, the electronic processor is further configured to in response to determining that the system user does not have sufficient user permissions to set the configuration file, transmit a request to a system administrator of the restricted area for permission to set the configuration file on behalf of the system user.

In some aspects, the set of user permissions include at least one selected from a group consisting of: permission to activate new configuration files, permission to unlock a selected access point using the physical access device, permission to unlock a selected access point at a selected time of day, permission to unlock a selected access point on a selected date, permission to transmit notifications to the system user, permission to transmit notifications to users different than the system user, permission to record an interaction with an expected visitor, and permission to enable AI-implemented voice conversations with an expected visitor.

In some aspects, the natural language input includes a natural language text input or a natural language audio input.

In some aspects, the electronic processor is further configured to derive, using the AI model, the natural language input from an electronic message.

In some aspects, the electronic processor is further configured to derive, using the AI model, the natural language input from an image including confirmation information relating to a scheduled event at the restricted area.

In some aspects, the electronic processor is further configured to in response to generating the configuration file, perform, with the AI model, self-correction on the configuration file.

In some aspects, the electronic processor is further configured to generate, using the AI model, a natural language description of the configuration file, and provide, via the user device, the natural language description and a prompt to confirm the expected event as described in the natural language description, wherein the electronic processor is configured to activate the configuration file in response to receiving, from the user device, confirmation of the expected event as described in the natural language description and determining that the system user has sufficient user permissions to activate the configuration file.

In some aspects, the electronic processor is further configured to in response to receiving, from the user device, user input indicating that the natural language description of the configuration file does not accurately describe the expected event, prompt the system user, via the user device, to provide additional information related to the expected event and update the configuration file based on the additional information.

Another example provides a method for controlling physical access to a restricted area. The method includes: receiving, from a user device associated with a system user, a natural language input relating to an expected event at a physical access device, wherein the system user is associated with a set of user permissions for configuring the physical access device; generating, using an artificial intelligence (AI) model, a configuration file for the physical access device based on the natural language input, the configuration file defining a set of actions and a set of conditions for performing the set of actions; determining whether the system user has sufficient user permissions to activate the configuration file; in response to determining that the system user has sufficient user permissions to activate the configuration file, activating the configuration file; detecting, via an input device, activity in proximity to the restricted area; determining whether the activity satisfies at least one condition of the set of conditions defined by the configuration file; and, in response to determining that the activity satisfies at least one condition of the set of conditions defined by the configuration file, executing the set of actions, wherein at least one action of the set of actions controls the physical access device.

In some aspects, the set of actions include at least one selected from a group consisting of: temporarily unlocking the physical access device to the restricted area, generating and transmitting, to the system user, a notification that the event has been detected, generating and transmitting, to user different from the system user, a notification that the event has been detected, generating and outputting, using a speaker device positioned in proximity to the restricted area, an audible instruction, and recording, using at least one camera, image data of a scene in proximity to the restricted area.

In some aspects, the expected event includes at least one selected from a group consisting of an expected visitor to the restricted area and an expected vehicle arrival to the restricted area.

Examples are herein described with reference to flowchart illustrations and/or block diagrams of methods, apparatus (systems) and computer program products according to examples. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some examples, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

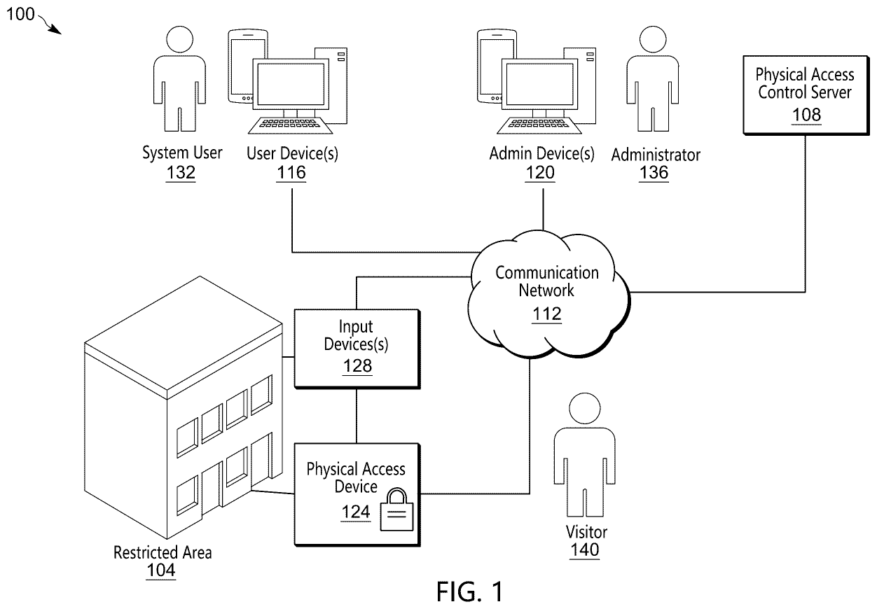

Further advantages and features consistent with this disclosure will be set forth in the following detailed description, with reference to the FIG. 28 Referring now to the drawings, FIG. 1 illustrates a physical access control system 100 for a restricted area 104. The system 100 includes a physical access control server 108 communicatively connected over a communication network 112 to a user device 116 (e.g., at least one user device 116), an administrator device 120 (e.g., at least one administrator device 120), a physical access device 124 (e.g., at least one physical access device 124), and an input device 128 (e.g., at least one input device 128). The restricted area 104 may include, for example, an office building, a government building, a manufacturing facility, a school, or other place of business. In some examples, the restricted area 104 includes a restricted roadway.

The communication network 112 includes, for example, one or more suitable wired or wireless networks for enabling communication between components of the system 100. For example, the communication network 112 may include a wide area network, a local area network, a WiFi network, a broadband network (e.g., a cellular network), or the like.

The user device 116 may include a mobile phone (e.g., a smart phone), a laptop, a desktop computer, or other suitable computing device. In some instances, the user device 116 is located within the restricted area. However, in other instances, the user device 116 may be located outside of the restricted area. For example, the user device 116 may be a mobile computing device. The user device 116 is associated with a system user 132 of the physical access control system 100. For example, the system user 132 may be an employee or other individual authorized for access to the restricted area 104. Further, while FIG. 1 is illustrated for simplicity as having one system user 132, the system 100 may include a plurality of system users 132 each associated with one or more user devices 116.

The administrator device 120 may include a mobile phone (e.g., a smart phone), a laptop, a desktop computer, or other suitable computing device. In some instances, the administrator device 120 is located within the restricted area. However, in other instances, the administrator device 120 may be located outside of the restricted area. For example, the administrator device 120 may be a mobile computing device. The administrator device 120 is associated with a system administrator 136 of the physical access control system 100. For example, the system administrator 136 may be a supervisor or other individual having administrative privileges of the system 100. Further, while FIG. 1 is illustrated for simplicity as having one system administrator 136, the system 100 may include a plurality of system administrators 136 each associated with one or more administrator devices 120.

The physical access device 124 includes one or more devices that selectively enable or restrict access to the restricted area 104. For example, the physical access device 124 may include an electronically controlled door (e.g., a building door, a garage door, etc.), an electronically controlled lock for a door, a turnstile, or other access regulating structure, an electronically controlled gate (e.g., a boom gate or other roadway gate), or the like. In some instances, the restricted area 104 includes a plurality of designated access points, and each access point includes at least one physical access device 124.

The input device 128 detects activity in proximity to the restricted area 104. For example, the input device 128 may include a camera (e.g., a video camera), a microphone, an intercom (e.g., a speaker and microphone combination), a keypad, a motion sensor, a barcode scanner, a radio frequency identification (RFID) scanner, a quick response (QR) code scanner, a doorbell, or a combination thereof. In some instances, the input device 128 is integrated with or otherwise communicatively connected to the physical access device 124. Activity detected in proximity to the restricted area 104 may include, for example, the presence of a system user 132, the presence of an administrator 136, the presence of a visitor (e.g., the visitor 140 illustrated in FIG. 1), the presence of a vehicle, or the like.

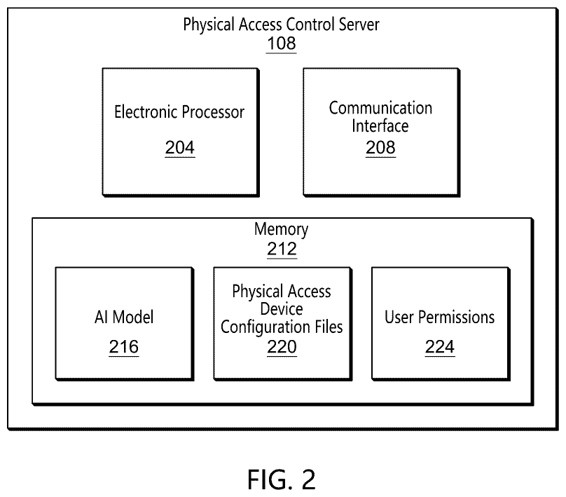

FIG. 2 schematically illustrates the physical access control server 108, according to some examples. The physical access control server 108, otherwise referred to herein as the server 108, includes an electronic processor 204 (e.g., at least one electronic processor 204) communicatively connected to a communicative interface 208 (e.g., at least one communication interface 208) and a memory 212 (e.g., at least one memory 212). The memory 212 stores information related to operation of the server 108, such as software or program instructions that, when executed by the electronic processor 204, cause the electronic processor 204 to perform, among other things, some or all of the methods described herein. For example, the memory 212 may store an artificial intelligence (AI) model 216, physical access device configuration files 220 for configuring physical access device 124, and user permission data 224 associated with the system user 132.

The electronic processor 204 may provide, using the communication interface 208, one or more graphical user interfaces (e.g., application or web interfaces) to the user device 116 and/or the administrator device 120 to receive physical access control requests, to provide notifications to the user device 116 and/or administrator device 120 relating to physical access control of the restricted area 104, to modify user permissions associated with physical access control of the restricted area 104, or the like.

The server 108 may be implemented in the cloud, on-premises of the restricted area 104, or both. For example, the server 108 may be implemented in a distributed manner. The server 108 may also include additional components than those illustrated in FIG. 2.

As described above, restricted areas such as places of business typically have more complex security protocols than those implemented in, for example, private residences. For example, personnel (e.g., employees or the like) may have varying levels of access to a restricted area (e.g., access to only certain doors, access to only certain sections of the restricted area, access to the restricted area only on certain days or during certain hours, etc.), and varying levels of authorization to accept visitors, deliveries, or the like in the restricted area.

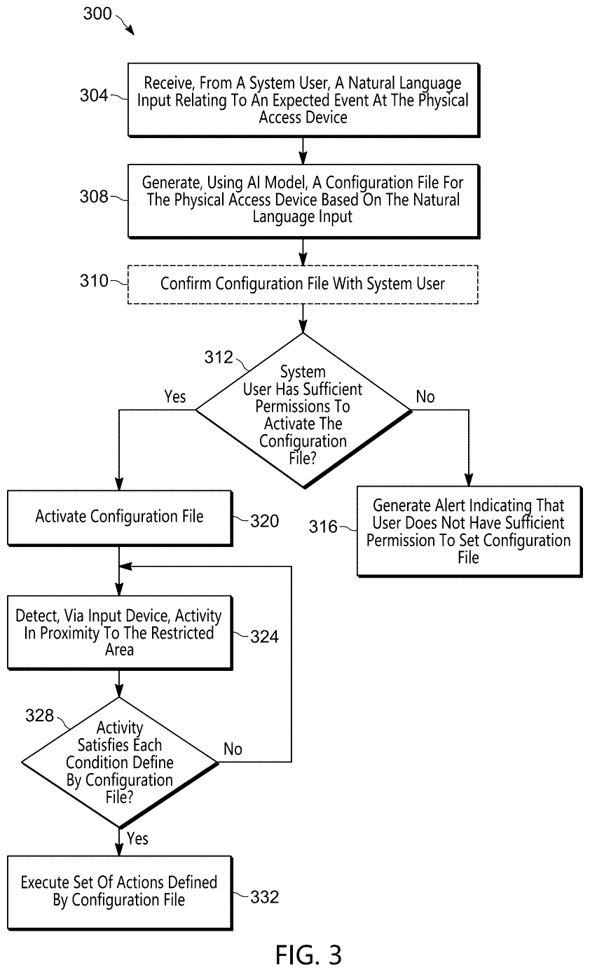

Therefore, FIG. 3 illustrates an example method 300 for controlling physical access to the restricted area 104. The method 300 is implemented by, for example, the electronic processor 204 in conjunction with other components of the server 108 and the system 100. The electronic processor 204 receives, from the user device 116 associated with the system user 132, a natural language input relating to an expected event at the physical access device 124 (at block 304). The expected event may include, for example, an expected visitor to the restricted area 104 (e.g., a delivery person, a technician, or other visitor) and/or an expected vehicle arrival to the restricted area 104.

The natural language input may include, for example, a natural language text input, a natural language audio input, or both. For example, the user device 116 may receive, as the natural language input, a text or a verbal description of the expected event from the system user 132, and the user device 116 may transmit the input to the server 108 over the communication network 112. The description of the event may include, for example, a date and time of the event, a description of a person or vehicle associated with the event, a description of a purpose of the event, a location of the expected event, or the like. When the natural language input is received verbally, the audio data may be initially transcribed to create a text description.

Using the AI model 216, the electronic processor 204 generates a configuration file for the physical access device 124 based on the natural language input (at block 308). The AI model 216 may be configured using a set of pre-trained large language models (LLMs). Over time, the electronic processor 204 fine tunes the AI model 216 based on, for example, interactions with system users 132 and other data gathered from physical access control requests.

The configuration file defines, for example, a set of actions and a set of conditions for performing the set of actions. The set of conditions may include a date or date range of the expected event, a time range of the expected event, a company associated with the expected event, an identifier of an expected visitor (e.g., a name or employee ID number), an identifier of an expected vehicle (e.g., a license plate number or a make and model), a confirmation code associated with the expected event (e.g., a delivery confirmation code), or a combination thereof. In some instances, the set of conditions includes a reference to image data of a face or other identifier related to the expected event (e.g., a face of an expected visitor).

The set of actions is, for example, a set of actions for controlling the physical access device 124 and/or other devices in the system 100 in response to the expected event being detected. The event is detected based on, for example, one or more conditions of the set of conditions being satisfied. For example, the set of actions may include temporarily unlocking the physical access device 124 (e.g., a selected physical access device 124). The selected physical access device 124 may be temporarily unlocked for a user-selected period of time or a default period of time, such as five minutes, ten minutes, one hour or the like. In some instances, the period of time for which the physical access device 124 is temporarily unlocked is set by the system administrator 136 via the administrator device 120 or set by the system user 132.

The set of actions may include generating and transmitting, to the system user 132 and/or a user different from the system user 132, a notification (e.g., a text notification, email notification, application notification, or the like) that the event has been detected.

The set of actions may include generating and outputting an audible instruction using a speaker device positioned in proximity to the restricted area 104. The instruction may be a user-selected instruction or statement (e.g., received as part of the natural language input at block 304) to be output to, for example, the visitor 140. In some instances, the electronic processor 204 generates the audible instruction using the AI model 216 or a different AI model.

In some instances, the set of actions includes controlling a camera in proximity to the restricted area 104 (e.g., an input device 128) to record image data of a scene in proximity to the restricted area 104.

By way of example, the natural language input received from the user device 116 may recite, “I'm expecting a food delivery from Company X at Door A tonight around eight o'clock PM.” The electronic processor 204 may parse the input with the AI model 216 and determine a set of conditions that include an event type (e.g., a food delivery), a date of the expected event (e.g., tonight), a time range of the expected event (e.g., between 7:30 PM and 8:30 PM), a location of the expected event (e.g., Door A), and a user associated with the expected event (e.g., the system user 132). The electronic processor 204 may determine a set of actions that include, for example, controlling a physical access device 124 associated with door A to an unlocked state.

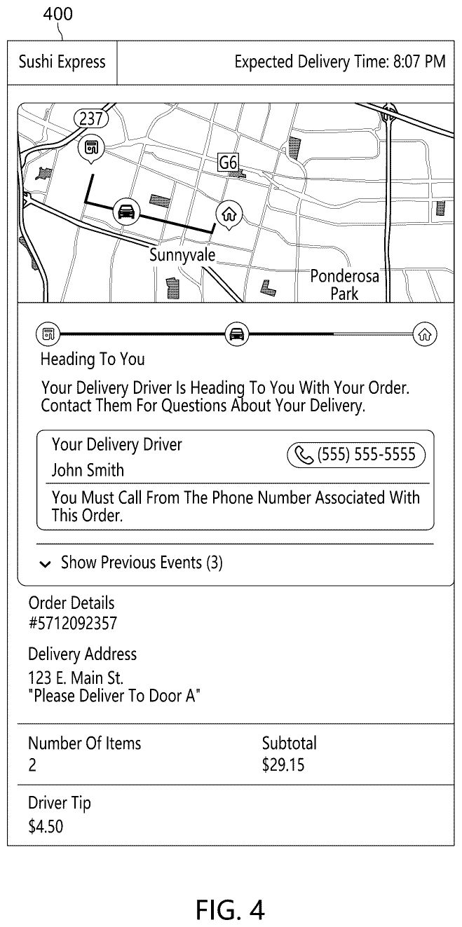

In some instances, the electronic processor 204 derives the natural language input from an image uploaded by the system user 132 using the user device 116. For example, the system user 132 may upload a screen capture of a scheduled delivery confirmation that includes details relating to the expected event. For example, FIG. 4 illustrates an example screen capture 400 from which the electronic processor 204 may derive the natural language input using the AI model 216. Based on the example input of FIG. 4, the electronic processor 204 may determine a set of conditions that include an event type (e.g., a food delivery), a time rage of the expected event (e.g., between 7:57 PM and 8:17 PM), a visitor name (e.g., John Smith), a delivery confirmation number (e.g., #5712092357), a location of the expected event (e.g., Door A), and a user associated with the expected event (e.g., the system user 132).

In some instances, the electronic processor 204 derives the natural language input from an electronic message (e.g., an email, text, or chat message) received on the user device 116. For example, by means of an application installed the user device 116, the electronic processor 204 may automatically detect that the user device 116 has received an email confirmation relating to a scheduled delivery to the restricted area 104, and the electronic processor 204 may generate the configuration file based on the email confirmation. The electronic processor 204 may be configured to monitor received messages and identify messages containing particular keywords (e.g., delivery, confirmation, receipt, etc.), received from particular sources (e.g., particular email addresses or companies), or the like. In some examples, a user can turn this message monitoring on and off and, when turned on, may configure the monitoring parameters and triggers. The electronic processor 204 may similarly use a machine learned model to detect electronic messages and may use feedback from a user to learn messages associated with expected events requiring processing.

In some instances, generating the configuration file includes automatically performing, with the AI model 216 or a secondary AI model, a self-correction on the configuration file. The self-correction may be limited to a predetermined number of attempts to fine-tune the generated configuration file. The self-correction may be performed using a rule-based method, using an AI model as a judge to perform a verification of the configuration file, or both.

The electronic processor 204 may generate the configuration file as a JSON file, an XML file, or other suitable format having fields for defining the set of conditions and set of actions. In some instances, the electronic processor 204 determines whether each required field of the configuration file is complete. In response to determining that at least one required field of the configuration file is not complete, the electronic processor 204 may prompt the system user 132, via the user device 116, to provide additional information relating to the expected event. Required fields may include, for example, a date of the expected event, a time of the expected event, a location of the expected event, a type of the expected event, or the like. In some instances, the required fields are defined by the system administrator 136 via the administrator device 120.

In some instances, the electronic processor 204 generates, using the AI model 216, a natural language description of the configuration file, provides the natural language description to the user device 116 over the communication network 112, and prompts the system user 132 to confirm the expected event as described in the natural language description (at block 310). For example, the electronic processor 204 parses the generated configuration file (e.g., the JSON file) using the AI model 216 and generates a natural language description of the set of conditions and set of actions for controlling the physical access device 124. This generated description further improves the user's experience with security system and limits the user's review and resources needed to create and activate the configuration file, which as noted above, leads to better usage of the security system and overall better security for the restricted area.

In response to receiving, from the user device 116, user input indicating that the natural language description does not accurately describe the expected event, the electronic processor 204 may prompt the system user 132, via the user device 116, to provide additional or clarifying information related to the expected event. The electronic processor 204 may then parse the additional information and update the configuration file based on the additional information. For example, the electronic processor 204 may update one or more of the conditions or actions defined by the configuration file to more accurately reflect the physical access control request of the system user 132.

As described above, personnel associated with the restricted area 104 may have different levels of authorization to access the restricted area 104 or otherwise control the physical access devices 124. Therefore, the electronic processor 204 determines whether the system user 132 has sufficient user permissions to activate the configuration file (at decision block 312). User permissions associated with the system user 132 may include permission to activate new configuration files, permission to unlock a selected access point using the physical access device, permission to unlock a selected access point at a selected time of day, permission to unlock a selected access point on a selected date, permission to transmit notifications to the system user, permission to transmit notifications to users different than the system user, permission to record an interaction with an expected visitor, permission to enable AI-implemented voice conversations with an expected visitor, or a combination thereof. The user permissions may be stored in the memory 212 (e.g., user permissions 224 illustrated in FIG. 2) and referenced by the electronic processor 204 using an identifier of the system user 132 received via the user device 116. In some instances, the electronic processor 204 receives or accesses the set of user permissions associated with the system user 132 in response to initiation of a physical access control application session on the user device 116.

In response to determining that the user does not have sufficient permissions to activate the configuration file (NO at decision block 312), the electronic processor 204 may generate an alert indicating that the user does not have sufficient permission to set the configuration file (at block 316). For example, the electronic processor 204 may prompt the system user 132 via the user device 116 to contact the system administrator 136 to request permission to set the configuration file or otherwise update the user permissions of the system user 132. In some instances, the electronic processor 204 automatically transmits the request to the system administrator 136 for permission to set the configuration file on behalf of the system user 132.

In response to determining that the system user 132 has sufficient permissions to activate the configuration file (YES at decision block 312), the electronic processor 204 activates the configuration file (at block 320). Activating the configuration file may include storing the configuration file (e.g., in the memory 212 as part of the physical access device configuration files 220), transmitting a command to configure the physical access device 124 according to the configuration file, or a combination thereof. The physical access device 124 may operate according to more than one configuration file. For example, multiple system users 132 associated with the restricted area 104 may submit respective physical access control requests with the system 100 related to different expected events. Additionally, a system user 132 may submit more than one physical access control request related to different expected events.

The method 300 further includes detecting, via an input device (e.g., the input device 128) activity in proximity to the restricted area 104 (at block 324). As described above, the input device 128 may include a camera, a microphone, an intercom, a keypad, a motion sensor, a barcode scanner, an RFID scanner, a QR code scanner, or the like. The input device 128 detects, for example, the presence of and/or actions performed by a visitor (e.g., the visitor 140), a vehicle, or another entity in proximity to the restricted area 104.

The electronic processor 204 determines whether the detected activity satisfies at least one condition of the set of conditions defined by the configuration file (at decision block 328). For example, the electronic processor 204 may determine whether the activity satisfies a threshold number of conditions. However, in some instances the electronic processor 204 determines whether the activity satisfies all conditions defined in the configuration file.

The electronic processor 204 may determine whether the activity satisfies one or more conditions by detecting a company logo worn by the visitor 140 detected at a scene in proximity to the restricted area 104 (e.g., via image processing performed on image data captured by the input device 128). For example, the set of conditions defined by the configuration file may include an indication of an employer of the visitor (e.g., a delivery company or other service).

The electronic processor may determine whether the activity satisfies one or more conditions by detecting (e.g., via a camera included in the input device 128 and associated image processing) a face of the visitor 140 detected at the scene. For example, the set of conditions defined in the configuration file may include a reference to image data of an expected visitor's face, and the electronic processor 204 may compare detected facial characteristics of a user at the scene to image data, facial characteristics, or a combination thereof included as part of the configuration file.

In some instances, the electronic processor 204 determines whether the activity satisfies a condition by detecting an object held by the visitor 140, such as a shipping box, a catering bag, or the like. In some instances, the electronic processor 204 determines whether the activity satisfies a condition by detecting a make and/or model of a vehicle detected at a scene in proximity to the restricted area 104. These detections may similarly be performed using image data captured by a camera at the scene and applicable image processing techniques.

The electronic processor 204 may determine whether the activity satisfies a condition by detecting a confirmation code presented by the visitor 140 at the scene, for example via a keypad, a camera, and/or a scanner included in the input device 128.

In some instances, the electronic processor 204 determines whether the activity satisfies a condition by detecting a verbal statement made by the visitor 140 at the scene (e.g., as captured by a microphone located at the scene). The verbal statement may indicate, for example, a name of the visitor 140, a purpose of the visit (e.g., deliver package, delivery food, perform maintenance, visit system user, etc.), an intended visitee of the visitor 140, a company associated with the visitor 140, or the like.

In some instances, the electronic processor 204 generates and outputs, using a speaker device positioned in proximity to the restricted area, a verbal prompt to the visitor 140 based on the set of conditions defined by the configuration file. For example, the verbal prompt may include a request for a name of the visitor 140, an intended purpose of the visitor, an intended visitee of the visitor, a company name associated with the visitor, a confirmation code associated with the event or the like. The speaker device may be a standalone device or may be integrated in one or both of the input device 128 and the physical access device 124. The verbal prompt may be an AI-generated prompt (e.g., generated using the AI model 216 or a different AI model). Accordingly, the electronic processor 204 may be configured to prompt a detected visitor for information needed to determine whether the set of conditions of a configuration file are satisfied (e.g., in situations where sufficient information cannot be determined passively).

In response to determining that the activity satisfies at least one condition (e.g., a predetermined number of conditions) of the set of conditions defined by the configuration file (YES at decision block 328), the electronic processor 204 executes the set of actions defined by the configuration file (at block 332). At least one action of the set of actions controls the physical access device 124. As described above, the set of actions may include temporarily unlocking the physical access device 124, generating a notification that the event has been detected, recording the scene in proximity to the restricted area 104, controlling a speaker device in proximity to the restricted area 104 to output an audible instruction, or the like. For example, the electronic processor 204 may generate and output an audible instruction to a visitor 140 to move to a particular access point of the restricted area 104, to enter the restricted area 104 through a particular access point, or to leave a package inside the restricted area 104.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot remotely control physical access control devices, among other features and functions set forth herein).

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains ...a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

The terms “substantially,” “essentially,” “approximately,” “about” or any other version thereof, are defined as being close to as understood by one of ordinary skill in the art, and in one non-limiting example the term is defined to be within 10%, in another example within 5%, in another example within 1% and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system for controlling physical access to a restricted area, the system comprising:
a physical access device configured to selectively enable access to the restricted area; and
an electronic processor communicatively connected to the physical access device, the electronic processor configured to
receive, from a user device associated with a system user, a natural language input relating to an expected event at the physical access device, wherein the system user is associated with a set of user permissions for configuring the physical access device,
generate, using an artificial intelligence (AI) model, a configuration file for the physical access device based on the natural language input, the configuration file defining a set of actions and a set of conditions for performing the set of actions,
determine whether the system user has sufficient user permissions to activate the configuration file,
in response to determining that the system user has sufficient user permissions to activate the configuration file, activate the configuration file,
detect, via an input device, activity in proximity to the restricted area,
determine whether the activity satisfies at least one condition of the set of conditions defined by the configuration file, and
in response to determining that the activity satisfies at least one condition of the set of conditions defined by the configuration file, execute the set of actions, wherein at least one action of the set of actions controls the physical access device.

2. The system of claim 1, wherein the set of actions include at least one selected from a group consisting of:
temporarily unlocking the physical access device to the restricted area,
generating and transmitting, to the system user, a notification that the event has been detected,
generating and transmitting, to user different from the system user, a notification that the event has been detected,
generating and outputting, using a speaker device positioned in proximity to the restricted area, an audible instruction, and
recording, using at least one camera, image data of a scene in proximity to the restricted area.

3. The system of claim 1, wherein the expected event includes at least one selected from a group consisting of an expected visitor to the restricted area and an expected vehicle arrival to the restricted area.

4. The system of claim 1, wherein the set of conditions include at least one selected from a group consisting of: a date range, a time of day range, a company associated with the expected event, an identifier of an expected visitor or an expected vehicle, and a confirmation code associated with the expected event.

5. The system of claim 4, wherein determining whether the activity satisfies at least one condition of the set of conditions defined by the configuration file includes detecting at least one selected from the group consisting of a company logo worn by a visitor detected at a scene in proximity to the restricted area, a face of the visitor detected at the scene, a confirmation code presented by the visitor at the scene, an object held by the visitor at the scene, and a verbal statement made by the visitor at the scene.

6. The system of claim 1, wherein the electronic processor is further configured to
determine whether each required field of the configuration file is complete, and
in response to determining at least one required field of the configuration file is not complete, prompt the system user, via the user device, to provide additional information relating to the expected event.

7. The system of claim 1, wherein determining whether the activity satisfies at least one condition of the set of conditions defined by the configuration file includes generating and outputting, using a speaker device positioned in proximity to the restricted area, a verbal prompt based on the set of conditions.

8. The system of claim 7, wherein the verbal prompt includes a request for at least one selected from a group consisting of: a name of a visitor, an intended purpose of the visitor, an intended visitee of the visitor, a company name associated with the visitor, a confirmation code associated with the event.

9. The system of claim 1, wherein the electronic processor is further configured to
in response to determining that the system user does not have sufficient user permissions to set the configuration file, prompt, via the user device, the system user to contact a system administrator to request permission to set the configuration file.

10. The system of claim 1, wherein the electronic processor is further configured to
in response to determining that the system user does not have sufficient user permissions to set the configuration file, transmit a request to a system administrator of the restricted area for permission to set the configuration file on behalf of the system user.

11. The system of claim 1, wherein the set of user permissions include at least one selected from a group consisting of: permission to activate new configuration files, permission to unlock a selected access point using the physical access device, permission to unlock a selected access point at a selected time of day, permission to unlock a selected access point on a selected date, permission to transmit notifications to the system user, permission to transmit notifications to users different than the system user, permission to record an interaction with an expected visitor, and permission to enable AI-implemented voice conversations with an expected visitor.

12. The system of claim 1, wherein the natural language input includes a natural language text input or a natural language audio input.

13. The system of claim 1, wherein the electronic processor is further configured to derive, using the AI model, the natural language input from an electronic message.

14. The system of claim 1, wherein the electronic processor is further configured to derive, using the AI model, the natural language input from an image including confirmation information relating to a scheduled event at the restricted area.

15. The system of claim 1, wherein the electronic processor is further configured to in response to generating the configuration file, perform, with the AI model, self-correction on the configuration file.

16. The system of claim 1, wherein the electronic processor is further configured to
generate, using the AI model, a natural language description of the configuration file, and
provide, via the user device, the natural language description and a prompt to confirm the expected event as described in the natural language description,
wherein the electronic processor is configured to activate the configuration file in response to receiving, from the user device, confirmation of the expected event as described in the natural language description and determining that the system user has sufficient user permissions to activate the configuration file.

17. The system of claim 16, wherein the electronic processor is further configured to
in response to receiving, from the user device, user input indicating that the natural language description of the configuration file does not accurately describe the expected event, prompt the system user, via the user device, to provide additional information related to the expected event and update the configuration file based on the additional information.

18. A method for controlling physical access to a restricted area, the method comprising:
receiving, from a user device associated with a system user, a natural language input relating to an expected event at a physical access device, wherein the system user is associated with a set of user permissions for configuring the physical access device;
generating, using an artificial intelligence (AI) model, a configuration file for the physical access device based on the natural language input, the configuration file defining a set of actions and a set of conditions for performing the set of actions;
determining whether the system user has sufficient user permissions to activate the configuration file;
in response to determining that the system user has sufficient user permissions to activate the configuration file, activating the configuration file;
detecting, via an input device, activity in proximity to the restricted area;
determining whether the activity satisfies at least one condition of the set of conditions defined by the configuration file; and
in response to determining that the activity satisfies at least one condition of the set of conditions defined by the configuration file, executing the set of actions, wherein at least one action of the set of actions controls the physical access device.

19. The method of claim 18, wherein the set of actions include at least one selected from a group consisting of:
temporarily unlocking the physical access device to the restricted area,
generating and transmitting, to the system user, a notification that the event has been detected,
generating and transmitting, to user different from the system user, a notification that the event has been detected,
generating and outputting, using a speaker device positioned in proximity to the restricted area, an audible instruction, and
recording, using at least one camera, image data of a scene in proximity to the restricted area.

20. The method of claim 18, wherein the expected event includes at least one selected from a group consisting of an expected visitor to the restricted area and an expected vehicle arrival to the restricted area.
